(19) United States
(12) Patent Application Publication
(10) Pub. No.: US 2008/0244425 A1
(43) Pub. Date: Oct. 2, 2008

(54) CALENDAR HORIZON VIEW

(75) Inventors: Erez Kikin-Gil, Mountain View, CA (US); Omar H. Shahine, Menlo Park, CA (US); Boaz Gurdin, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/692,164

(22) Filed: Mar. 27, 2007

(51) Int. Cl. G06F 3/048

(52) U.S. Cl. 715/764

(57) ABSTRACT

A calendar application is disclosed for emphasizing current and near time periods. The calendar application may provide a calendar interface which displays the current time period in the left-most column. Thus, in an example where the calendar interface displays a week of time, the calendar interface may display the current day first, and not Sunday or Monday as in conventional calendar applications. When the calendar interface is configured to show multiple rows of time periods, the calendar application may additionally or alternatively display some of the rows larger relative to others of the displayed rows. For example, in a monthly view displaying four weeks, a default view may present the first and second rows, representing the current week and the following week, with a larger area on the display than the last two rows representing the third and fourth weeks from the current date.

### BACKGROUND

Software application programs commonly referred to as personal information managers, or PIMs, have become extremely popular as a tool for organizing, tracking and managing personal information. One aspect of a PIM is a calendar application program which provides a user interface including a graphical representation of a calendar. The user may select to display a day, week, month, etc. Using the calendar interface, a user may record appointments, events and other information. Calendar application programs also provide automatic notifications and reminders about upcoming appointments and events. Calendar application programs typically communicate and exchange information with other PIM application programs, such as for example email and contact application programs, as well as other datastores.

PIM and calendar applications provide limited display options for time periods. In particular, conventional applications do not accurately coincide with user priorities or experiences. The fact is that people tend to focus on the events that occur nearest in time. Events happening today are typically of greater interest to users than events associated with a day the following week. However, conventional calendar applications do not adequately take these priorities and experiences into account. Weekly displays in conventional applications are centered around the beginning of the week; that is, the calendar applications start each displayed week with either Sunday or Monday, regardless of what the day actually is. Moreover, even though a user is typically more interested in events occurring in the present as opposed to the future, in conventional applications, the current and future time periods are uniformly displayed; that is, the space allotted on the user interface for the current day is the same size as the following day, following week, etc. Further still, calendar applications tend to schedule events by specific times; that is, by the time an event starts and a time the event ends. People tend instead to focus on time periods. A user needs to perform an event for example tomorrow afternoon, but not necessarily at a specific time in the afternoon.

### SUMMARY

The present technology, roughly described, pertains to a calendar application mirroring user priorities and experiences by emphasizing current and near time periods. In one embodiment, the calendar application provides a calendar interface which displays the current time period in the left-most column (or right-most column in societies reading right to left). Thus, in an example where the calendar interface displays a week of time, the calendar interface may display the current day first, and not Sunday or Monday as in conventional calendar applications. This provides the user with a calendar view showing only the imminent and upcoming events, and is more in tune with the user's priorities and preferences.

In a further embodiment of the present system, when the calendar interface is configured to show multiple rows of time periods, some of those rows may be made larger relative to others of the displayed rows. For example, in a monthly view displaying four weeks, a default view may present the first and second rows, representing the current week and following week, with a larger area on the display than the last two rows representing the third and fourth weeks from the current date.

The calendar application may be implemented as a client application or a network-based application. A client calendar application can store user calendar data locally on the client device. In this case, event objects associated with different time periods may be added, changed and removed from the local client device as a user configures his or her calendar. A network-based calendar application may save user calendar data remotely, using a calendar application or browser application on a client device which can access a remote server over a network. When implemented using a browser application, the application may access a web service provided by one or more web servers and/or related devices.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing system environment capable of executing the calendar application program according to the present system.

FIG. 2 illustrates a block diagram of an embodiment of a system for providing a calendar application by a client application.

FIG. 3 illustrates a block diagram of an embodiment of a system for providing a calendar application by a browser application.

FIG. 4 illustrates a flowchart of an embodiment of a process for providing a calendar application.

FIG. 5 illustrates a flowchart of an embodiment of a process for processing an event object.

FIG. 6 illustrates a flowchart of an embodiment of a process for adjusting a calendar interface.

FIG. 7 is an example of a calendar application interface according to the present system.

FIG. 8 is an example of a calendar application interface according to the present system.

### DETAILED DESCRIPTION

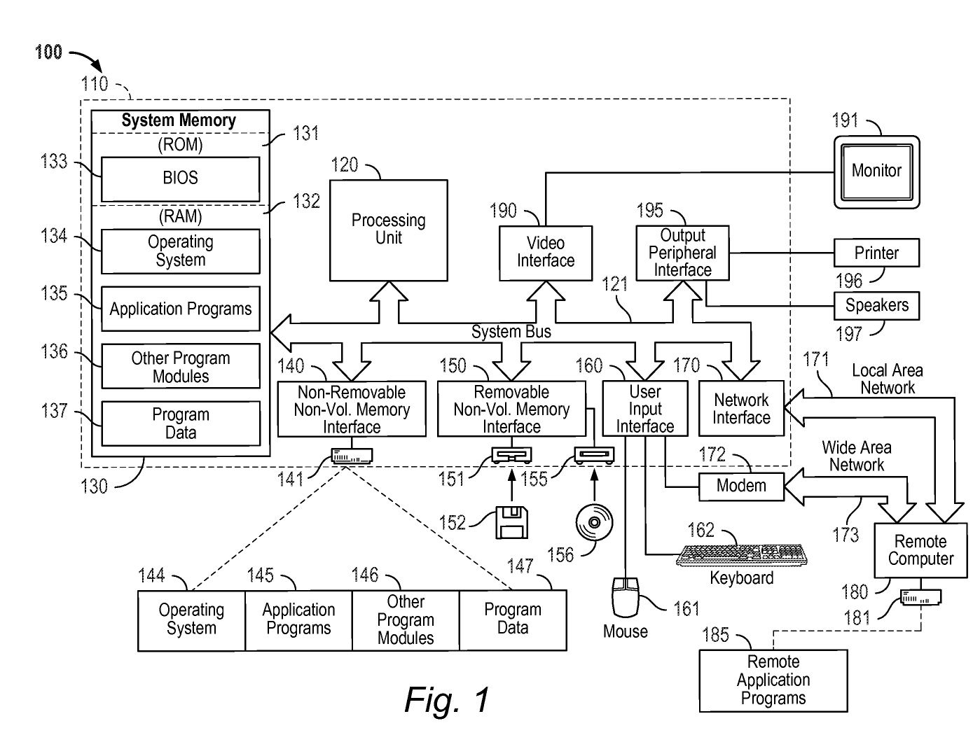

The present system will now be described with reference to FIGS. 1 through 8, which in general relate to a calendar application program mirroring user priorities and experiences by emphasizing current and near time periods. The application program allows a user to manage events during time periods of one or more days, weeks or months. FIG. 1 illustrates an example of a suitable general computing system environment 100 on which the calendar application according to the present system may be implemented. The computing system environment 100 is only one example of a suitable computing environment and is not intended to suggest any limitation as to the scope of use or functionality of the system. Neither should the computing environment 100 be interpreted as having any dependency or requirement relating to any one or combination of components illustrated in the exemplary operating environment 100.

The system is operational with numerous other general purpose or special purpose computing system environments or configurations. Examples of well known computing systems, environments, and/or configurations that may be suitable for use with the system include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc., that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices.

FIG. 1, an exemplary computing environment for implementing the present system, includes a general purpose computing device in the form of a computer 110. Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tapes, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/ nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor 191, computer 110 may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The calendar application may be implemented on a client device or over a network. When implemented on a client device, the calendar application is provided by a calendar client application. The client application reads and writes calendar data from the client device memory. When implemented over a network, at least a portion of the user data for the calendar application may be stored on a remote server. In this case, the calendar application may be provided using a client application which accesses the remote server or through a browser application which accesses a web server providing a content page. In the case of a browser application, the content page provides the calendar interface. When provided over a network, the calendar application allows the user to schedule and share events with other users, view log-in status and other information for other users, and other information.

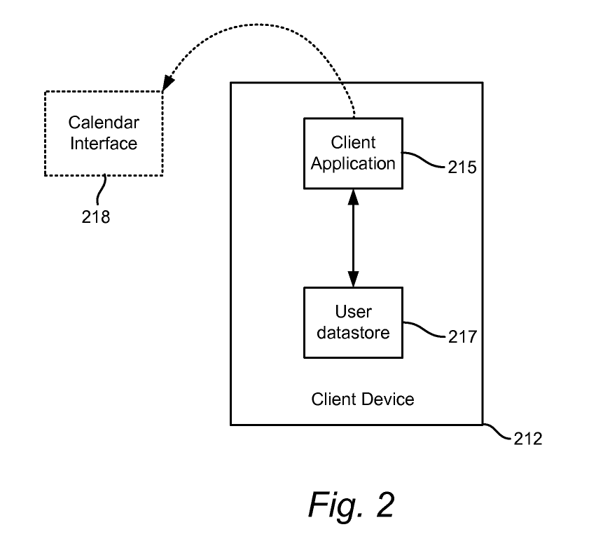

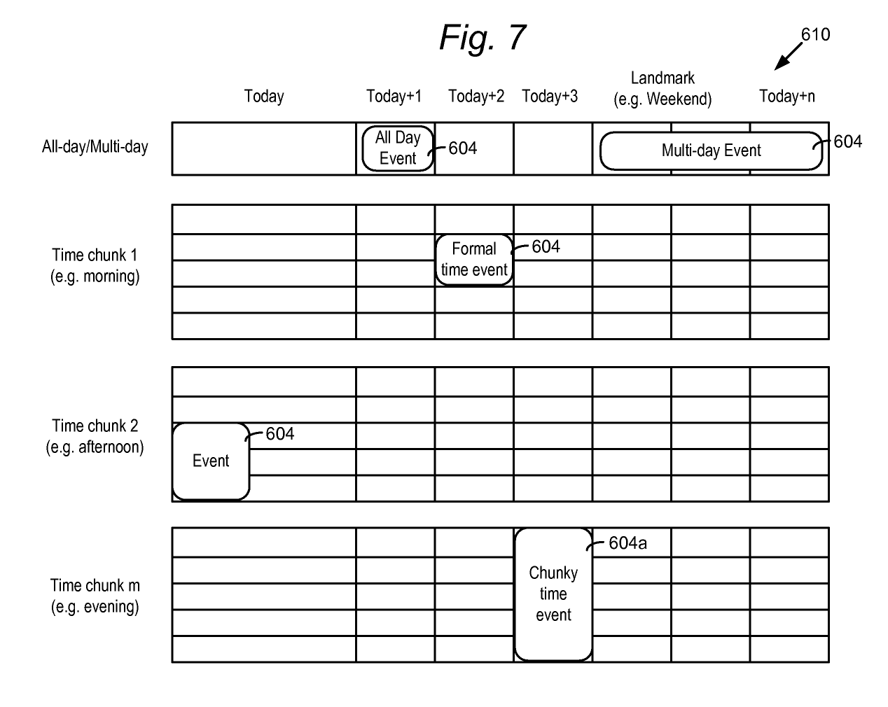

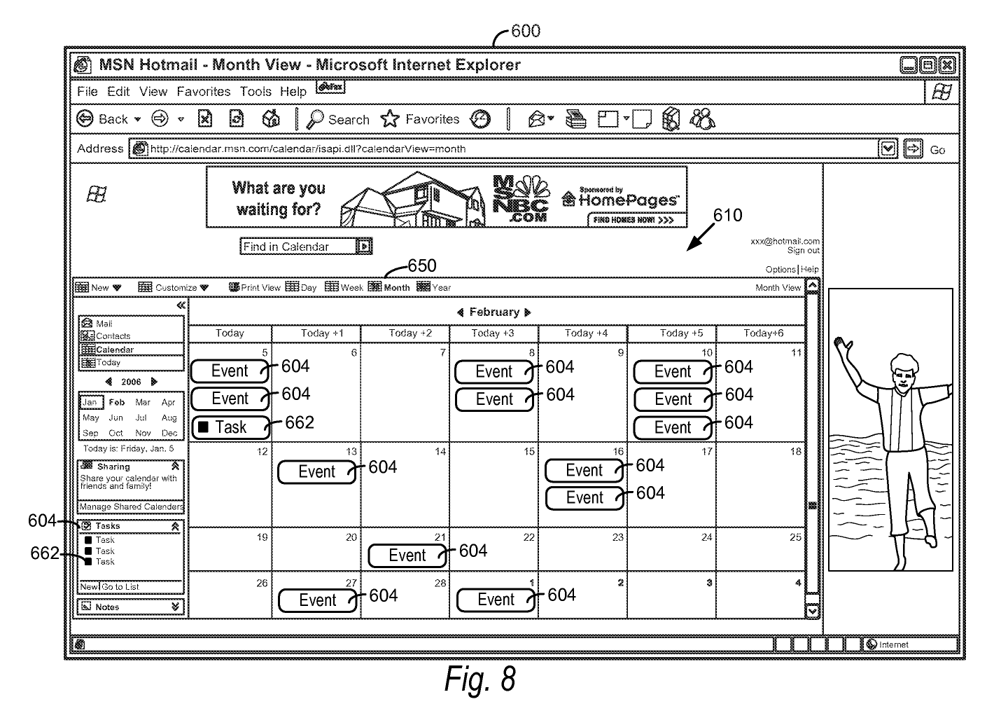

The calendar application of the present technology is discussed in more detail below. In particular, systems and methods associated with calendar application functionality and operation are discussed below with respect to FIGS. 2 through 6. Examples of calendar application interfaces are discussed below with respect to FIGS. 7 through 8.

FIG. 2 illustrates a block diagram of an embodiment of a system for providing a calendar application by a client application 215 and a user datastore 217. The client application 215 and datastore 217 may be implemented on a client device 212. Client device 212, as well as client device 220, network server 232 and/or user datastore 240 described hereinafter with respect to FIG. 2, may each be implemented by the computing environment 100 described above.

Client application 215 may communicate with user datastore 217 within client device 212. In one embodiment, client application 215 may be implemented as a calendar application, PIM application or some other application which allows a user to manage a calendar application. Client application 215 also provides calendar interface 218, as indicated by the dotted lines in FIG. 2. The calendar interface 218 is provided through a display device 191 (FIG. 1) associated with client device 212.

User datastore 217 includes user data associated with the calendar application. The user data may include the event object data associated with the user, user authentication information, calendar parameters configured by the user, and other data used to configure or populate a calendar interface or otherwise associated with the user. In one embodiment, user datastore 217 may be implemented by the local memory of client device 212.

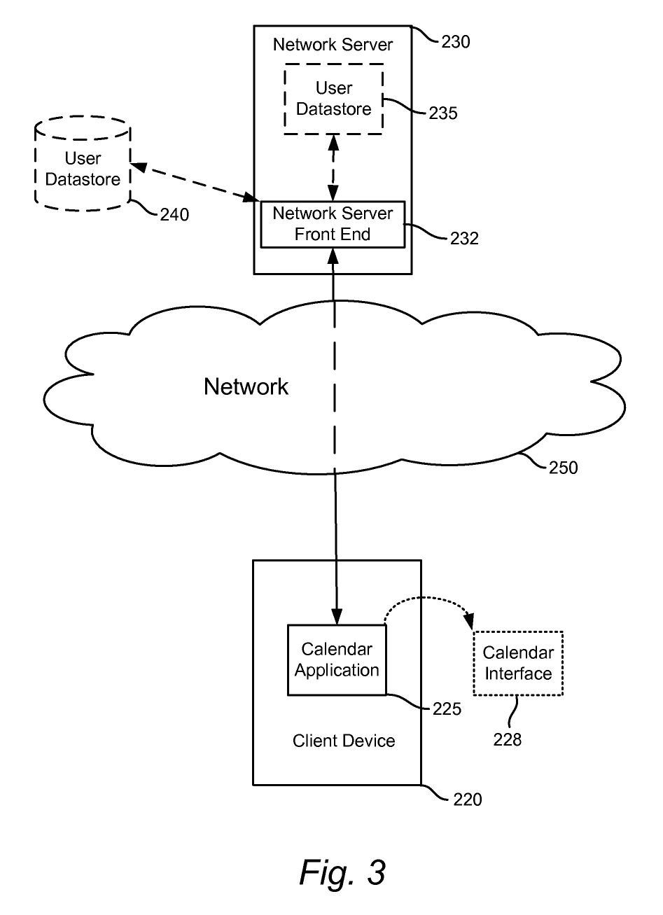

FIG. 3 illustrates a block diagram of an embodiment of a system for implementing a calendar application over a network. FIG. 3 includes client device 220, network server 230, and network 250. FIG. 3 may optionally include user datastore 240. Client device 220 may further include browser application 225. Browser application 225 communicates with network server 230 over network 250. In one embodiment, network 250 may be implemented as the Internet. Though the system of FIG. 3 includes a browser application on client device 220, other applications could be used to implement a calendar application and access user calendar data from a server over a network. Examples of other applications for implementing a calendar application include a PIM application, a client calendar application which accesses data over a network, and other applications.

Browser application 225 may communicate with network server 230 to retrieve and provide content pages. In one embodiment, browser application 225 may provide calendar interface 228 as a content page. In an embodiment wherein another type of application is used to provide a calendar application and access data from a server over network 250, the particular application would provide calendar interface 228.

Network server 230 includes network server front-end 232 and can optionally include user datastore 235. Network server front-end 232 receives and transmits messages from requesting client devices, such as client device 220. The received messages may include content requests, authentication requests, and other messages. The messages sent by network server front-end 232 may include content responses sent in response to a request, authentication responses, and other messages. Network server front-end 232 provides the calendar application functionality described herein. Operation of network server front-end 232 is discussed in more detail below.

Network server front-end 232 may also access user datastore 235. User datastore 235 is optional, as indicated by the dashed lines comprising user datastore 235 in FIG. 3. In one embodiment, network server front-end 232 may access remote user datastore 240. User datastore 240 is also optional, as indicated by the dashed lines comprising the datastore. In some embodiments, network server front-end 232 may access either or both datastores. Whichever datastore is used, user calendar data can be added, removed, changed and processed at each datastore. As discussed above, user calendar data (and/or user data) may include event object data, user authentication data, calendar parameter and settings data, and other user data associated with a calendar application.

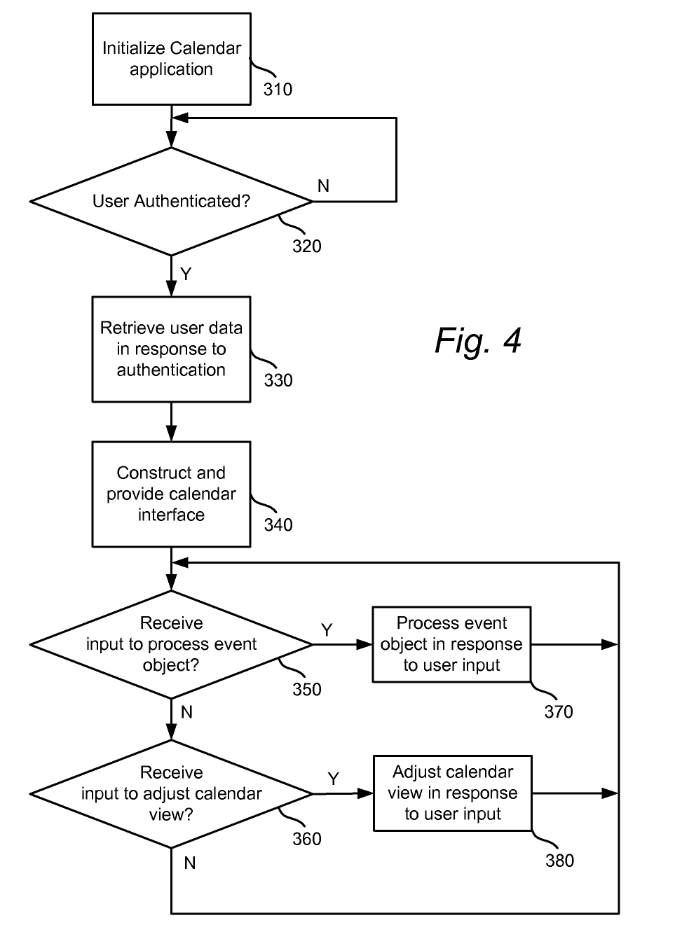

FIG. 4 is a flowchart of an embodiment of a process for providing a calendar application according to the present system. The flowchart of FIG. 4 may be used to implement a calendar application locally on a client device as discussed with respect to client device 212 or with an application such as browser application 225 which accesses user data over a network.

First, a calendar application is initialized at step 310. Initializing a calendar application involves starting up the application which provides the calendar interface. If the application accesses data over a network, initializing the application may include detecting a network connection on the client device on which the application resides. Next, a determination is made as to whether a user is authenticated at step 320. In one embodiment, after initializing the calendar application at step 310, the calendar application will provide an authentication interface to a user. The authentication interface may allow a user to enter a user name, password, and/or other authentication information. Once a user name and password are received, the calendar application may confirm that the user name and password match information stored in the appropriate user datastore. If the user name and password information received from a user matches user and password information stored in a datastore, then the user is authenticated.

In the case of a locally implemented calendar application, the user name and password are compared with data stored in user datastore 217 on client device 212. If user data is accessed over network 250, the application determines if the received user name and password match user name and password information stored on user datastore 235 or user datastore 240. In this case, an authentication request is sent to network server 230 by client device 220. Network server front-end 232 receives the authentication request and sends an authentication request to user datastore 235 or user datastore 240. The appropriate user datastore receives the request, determines if the user name and password match user data stored in the user datastore, and provides an authentication response to network server front-end 232. The authentication response indicates whether the authentication was successful. Network server front-end 232 forwards the authentication response to the requesting client device 220.

If the user name and password information received from a user matches user and password information stored in a datastore, then the user is authenticated and the flowchart of FIG. 4 continues to step 330. If the user is not authenticated at step 320, the flowchart remains at step 320.

User data is retrieved in response to the authentication at step 330. In one embodiment, the user data retrieved can be associated with a default interface or the last calendar view provided in the calendar interface. The data may be retrieved from local datastore 217 or remote user datastore 235 or 240 depending on the implementation of the calendar application. In the case of a local datastore, client application 215 retrieves the user data from user datastore 217. When accessed from local user datastore 217, the user data may include a series of files. Each file may include data associated with an event object for a user. For example, an event object may include data for a dinner appointment, a sporting event, a wedding, or some other event associated with the user.

User data may also be retrieved from remote datastores 235 and/or 240. In the case of a network-based calendar application, browser application 225 may request the user data from network server 230. Network server 230, or network server front-end 232, may process the request similar to the authentication request discussed above. However, instead of comparing received user authentication information to stored user authentication information, the appropriate user datastore retrieves requested user data and places the data in a response. The response is then sent to network server front-end 232, which receives the response and sends it to the requesting application.

After user data has been retrieved, the calendar application interface is constructed and provided at step 340. As explained in greater detail hereinafter, the calendar application interface may be presented in a manner that reflects and is optimized for user priorities and experiences. In one embodiment, the calendar application interface is constructed and populated with the retrieved data. The constructed interface may be a default calendar interface or the last interface accessed by the user. Once the interface is constructed, the event objects associated with the user are populated within the interface.

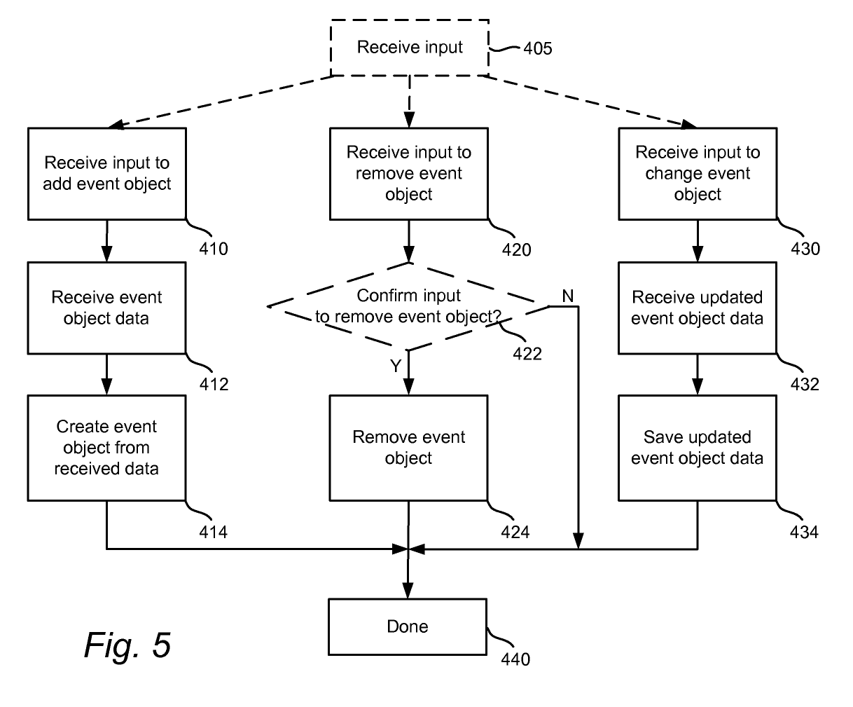

After constructing and providing the calendar application interface, a determination is made as to whether input is received to process event objects at step 350. In one embodiment, receiving input to process an event object includes receiving input to add, change or delete an event object. If input is received to process an event object at step 315, the flowchart of FIG. 4 continues to step 370. Event objects are processed in response to user input at step 370. Processing the event object may include adding, removing or changing the appropriate event object and updating the calendar application interface in response to processing the object. Processing the event object at step 370 is discussed in more detail below with respect to FIG. 5. After the event object is processed, the flowchart of FIG. 4 returns to step 350. If input is not received to process an event object at step 350, the flowchart of FIG. 4 continues to step 360.

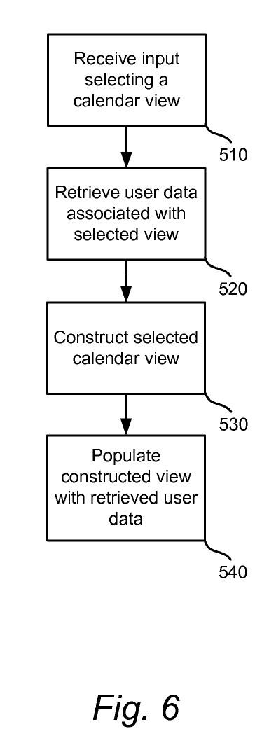

A determination is made as to whether input is received to adjust a calendar view at step 360. Receiving input to adjust a calendar view may be associated with changing the actual calendar view or calendar view parameters. Changing the actual view may include providing a daily, weekly, monthly or other calendar view within the calendar interface. If input is received to adjust a calendar view, the flowchart of FIG. 4 continues to step 380 where the calendar view is adjusted in response to the user input. Adjusting the calendar view in response to user input is discussed in more detail below with respect to FIG. 6. After the calendar view is adjusted, the flowchart of FIG. 4 continues to step 350. If no input is received to adjust a calendar view at step 360, the flowchart of FIG. 4 returns to step 350.

Event objects provided within a calendar interface may be configured in response to user input. FIG. 5 is a flowchart of an embodiment of a process for processing an event object. In one embodiment, the flowchart of FIG. 5 provides more detail of step 370 of FIG. 4 discussed above. Several types of input may be received from a user through a calendar interface. Types of input that may be received include input to add event object data, remove event object data, and change event object data. The input can be received through a drop down menu, command line, selection of an icon or other element of an interface, or in some other manner. Input received to add an event object, remove an event object, and change an event object are discussed below with respect to steps 410, 420 and 430, respectively, of the flowchart of FIG. 5.

Input may be received to add an event object at step 410. In one embodiment, input to add an event object may be received through a calendar interface as a selection of a particular time slot or block within a calendar interface, a selection of an element within a drop down menu, a selection of an icon, or some other input. As explained hereinafter, a task set forth on the task list may also be added to a calendar by dragging and dropping the task into a particular time slot.

Next, the event object data is received at step 412. The event object data is received from a user. In one embodiment, receiving the event object data may include providing an interface in response to the input received at step 410. The interface may allow a user to input data associated with the event object. For example, the interface may allow a user to select a category for an event object. Exemplary event object categories may include a dinner appointment, a sporting event, a party and other events. The interface may then allow a user to enter meta-data regarding the event object into the interface. The meta-data may include general data and/or data tailored to the particular event. For example, for a dinner event, the entered meta-data may include a name for the event, name of the restaurant, location of the restaurant, a name under which a dinner reservation is made and other information.

After the event object data is received, an event object is created from the received data at step 414. In the case of a calendar application implemented entirely on client device 212, the event object data is saved by client application 215 to user datastore 217. After the data is stored to user datastore 217, an event object may be provided in the current calendar interface, if appropriate. For example, the event object will be displayed in the calendar interface if the event object corresponds to a time currently provided in the calendar interface view.

For a calendar application in which the event object is saved remotely, creating the event object from the received data includes storing the event object data on a datastore associated with a network server. With respect to FIG. 3, browser application 225 will send the event object data in a write message to network server 230. Network server front-end 232 receives the write message and forwards the write message to either user datastore 235 or user datastore 240. In one embodiment, when stored at a remote datastore, the user event object data is stored in a table format. The table may include user identification information and event object data associated with the user identification information. After receiving a confirmation that the data is stored on the appropriate datastore, network server front-end 232 sends a confirmation to browser application 225 that the event object data has been stored. In addition to sending the event object data to a remote datastore, browser application 225 can provide the received event object data in the current interface if the event object data is associated with a time included in the current calendar view. After the event object is created from the received data at step 414, the flowchart of FIG. 5 ends at step 440.

Input may be received to remove an event object at step 420. The input may be received as a selection from a drop down menu associated with the event object, selection of an icon or some other input within the calendar interface. A determination is then made as to whether a user has confirmed to remove the event object at step 422. Step 422 can be optionally performed to confirm that the event object should be removed from the calendar interface and appropriate user datastore. In one embodiment, step 422 includes providing a user prompt inquiring whether the user wishes to remove the object data, as well as buttons for removing or not removing the object. User selection of one of the buttons satisfies the determination as to whether the user confirms removal of the event object. If confirmation input is received that the event object should be removed, the flowchart of FIG. 5 continues to step 424. If input indicates that the event object should not be removed (or no input is received at all), the flowchart of FIG. 5 ends at step 440.

At step 424, the event object is removed. Removing the event object may include removing the actual object data from the calendar interface and deleting the data from the appropriate datastore. In the case of a calendar application implemented entirely on a client device, client application 215 sends a message to user datastore 217 to remove the event object. In the case of a calendar application implemented using a remote datastore, browser application 225 sends a message to network server 230 to remove the particular user event object data from user datastore 235 or user datastore 240. In this case, network server front-end 232 receives the user request information and processes the user request by sending a message to user datastore 235 or user datastore 240. Network server front-end 232 receives a confirmation message from the appropriate datastore once the event object data is removed from the appropriate datastore, and forwards the confirmation message to browser application 225. The flowchart of FIG. 5 then continues to step 440 where the flowchart ends.

Input may be received to change an event object at step 430. Input may be received to change an event object by user selection of an existing object in a calendar interface. The input may select the event object and then an entry within a drop down menu associated with the event object, a double-click of the object or some other input. Next, updated event object data is received at step 432. Similar to step 412 discussed above, the updated event object data may be received through an interface provided in response to selection of the event object. In one embodiment, updating event object data may include changing existing data, adding missing data, or removing existing data in the interface. After the updated event object data is received at step 432, the updated event object data is saved at step 434. Similar to step 414 discussed above, saving updated event object data may include storing the object data on a local or remote datastore. In addition to saving the event object data, the updated event object data is provided in the appropriate calendar interface view. The flowchart of FIG. 5 then ends at step 440.

In embodiments, the appearance of the user interface may be user-configurable. In particular, as shown hereinafter in FIG. 8, a user may select to display the weekly, monthly or other time period view with the current day being displayed in the left-most column. Moreover, as shown in FIG. 8, in the monthly view, the current week, and possibly one or more additional following weeks, are displayed with a larger space than the remaining weeks displayed on the calendar interface. Each of these attributes may be selected and configured by a user. In alternative embodiments, these attributes may be automatically presented on the calendar user interface and not user configurable.

FIG. 6 is a flowchart of an embodiment of a process for adjusting a calendar view where the view is user configurable. In one embodiment, the flowchart at FIG. 6 provides more detail of step 380 of FIG. 4. First, input selecting a calendar view is received at step 510. The input may be received through a calendar interface. In one embodiment, the user may select a default view from a window provided on the calendar interface, such as window 610 on FIG. 8. Additionally or alternatively, a user may be provided with an option, for example from a “Customize” layout option on a menu 650 (FIG. 8), to customize the calendar interface. The menu 650 may provide the user with several options. In addition to the option to display the calendar interface by day, week, month or other time period, the “Customize” layout option may present the user with the option of setting the starting day for the display. If this option is selected, a pop-up window or the like may be displayed to the user presenting the user with options to set the calendar interface to display the selected time period starting with the current day, Sunday or Monday (as in traditional calendar interfaces) or any user-defined start day or date. Once this option is set, the selected start day will be displayed in the left-most column on the calendar interface 610. The default may be to display the time period with the current day in the left-most column.

In addition, the “Customize” layout option may present the user with an option to set the number of weeks displayed in a monthly view. Conventional calendar interfaces display five or six weeks. However, typically a user's realistic event horizon is shorter than this. Accordingly, when this option is selected from the “Customize” layout menu, the user may be presented with a pop-up window or the like giving the user the option to define the number of weeks to display in the calendar interface. The default may be to display four weeks in a monthly calendar view. The same may be done for the daily calendar view, giving the user the option to set the number of hours to display, or the number of time chunks (explained hereinafter) to display.

The “Customize” layout option may further present the user with the option to set the size in which a given time period is displayed relative to other time periods on the display. If a user selects this option, the user may be presented with a pop-up window or the like presenting the user with the option to set relative time period display sizes for the currently selected time period.

Thus, as an example, if the calendar interface is currently set to display a monthly view including four weeks, the pop-up window may present the user with the option to divide up the size in which the weeks are displayed on the calendar interface. As one of many possible configurations for the pop-up window, the window may display an option for each week (e.g., “week 1,” “week 2,” etc.) along with the option of setting the size of that week relative to the other weeks by a percentage out of one-hundred percent (e.g., “week 1: 40%,” “week 2: 40%,” etc.). Once the percentage breakdown of each displayed time period is set, the calendar interface may be constructed by the calendar application program according to the user selections. Thus, with the above-described sample settings, the first week would be displayed taking up 40% of the available width (from top of the calendar interface to bottom of the calendar interface), the second week would be displayed taking up 40% of the available width, etc. Other possible configurations are contemplated for setting the size in which each time period is displayed on the calendar interface. For a monthly view of four weeks, the default may be to display the first two weeks on the interface as being larger than the last two weeks, for example, twice as large in one embodiment.

Referring again to the flowchart of FIG. 6, after receiving input from the “Customize” layout option, user data associated with the selected interface view is retrieved at step 520. The retrieved user data may include event objects, user parameters and other data, and is associated with the interface view selected at step 510. Where a user has selected a given time period to be displayed, the request will include parameters which specify the days and times for each day for which data is requested. The datastore receiving the request retrieves the user data that match the request. For example, if the selected view is a one week view, such as that illustrated in FIG. 7, the user data occurring in that week is retrieved.

In the case of a calendar application implemented on a client device, user datastore 217 receives the request from client application 215. In the case of a calendar application implemented over a network, network server front-end 232 receives the request and forwards the request to either user datastore 235 or user datastore 240. The receiving user datastore retrieves the data and provides a response containing the data to network server front-end 232. The response is then forwarded by network server front-end 232 to browser application 225.

The selected calendar view is constructed at step 530. In this case, the days and timelines associated with each day are provided in the calendar interface. The constructed calendar may be a new calendar view or a modified calendar view, depending on the input received at step 510. Once the selected calendar view is constructed, the constructed view is populated with the retrieved user data at step 540. In this case, a constructed calendar view is populated with event objects retrieved at step 520. The event objects are displayed as visual indicators within the calendar interface at a time slot associated with the event object. The indicator may provide summary information associated with the event. Upon user selection of the visual indicator, more detail can be provided regarding the particular event object. The additional detail may include additional meta-data associated with the event object which is not displayed in the calendar interface indicator.

As described in the Background section, conventional PIM and calendar applications do not accurately coincide with user priorities or experiences. While people tend to focus on the events that occur proximately in time, conventional calendar applications do not give more focused treatment to the nearest upcoming time periods. The present system addresses this issue. Examples are shown on the calendar interface 610 of FIGS. 7 and 8. FIG. 8 shows the calendar interface 610 presented by a browser webpage 600. It is understood that the calendar interface 610 of FIG. 7 may similarly be displayed in a browser webpage 600.

In the embodiment shown in FIG. 7, a time period may be presented on the calendar interface 610 which begins with the current day, instead of Sunday or Monday as in conventional calendar interfaces. Operating systems keep track of the current date. This information may be used by the calendar application program to construct a calendar interface 610 with the current day in the left-most column, and succeeding days thereafter left to right. In cultures that read right to left, it is understood that the current day or time period may be provided in the right-most column, with succeeding days or time periods thereafter right to left. As indicated above, the user may be given the option to specify the number of time periods the user wishes to be displayed on the calendar interface. Thus, the calendar interface may display the current day, and then any number, n, of following days on the calendar.

The user may associate a plurality of events 604 with time periods on calendar interface 610 as described above with respect to FIG. 5. As seen in FIG. 7, a top row of the calendar interface may be dedicated to all-day or multi-day events 604. Thereafter, the displayed days provide time chunks in which events 604 may be performed. Additional details of this type of time division in a calendar interface are explained in U.S. patent application Ser. No. ______, entitled “Entering and Using Time Ranges,” to Malinda Nascimbeni et al., filed Jun. 7, 2006, which application is incorporated by reference herein in its entirety. In general, the concept of time chunks relates to the fact people often do not schedule events by a particular time, but rather for a general time period. For example, a user may want to plan some event 604a, but instead of having a specific time, they only know they want to perform the event in the morning, the afternoon or the evening. The calendar interface shown in FIG. 7 reflects this user preference by allowing a user to schedule by time chunk instead of by specific time. While FIG. 7 shows time chunks of morning, afternoon and evening, it is understood that a user may define any chunk(s) of time they would like. The calendar interface shown in FIG. 7 also includes lines indicative of specific times. The calendar application program of the present invention also provides the user the ability to schedule by specific times.

FIG. 8 displays a further example of a webpage 600 including a calendar interface 610. Interface 610 includes a tool bar 650 having several buttons allowing a user to configure interface 610 and event objects within interface 610. In particular, tool bar 650 includes buttons associated with a “new” calendar object, “customize” layout and “print view.” Toolbar 650 may further include a list of user selectable views. Toolbar 650 includes a day view, week view, month view and year view. Other options may be provided on tool bar 650 in further embodiments.

The “new” button allows a user to generate new event objects. Generation of a new event object is discussed in more detail above with respect to the flowchart of FIG. 5. The “customize” button allows a user to configure the layout of the calendar. The options presented to the user upon selection of the “customize” option is discussed in more detail above with respect to the flowchart of FIG. 6. The “print view” button allows a user to view an image of the calendar as it will appear when printed. As indicated above, the tool bar 650 may also be included on the calendar interface 610 shown in FIG. 7.

Calendar interface 610 shown in FIG. 8 further includes a display of a time period, as well as a plurality of events 604 associated with times within that period. In accordance with a further aspect of the present system, when multiple rows of time periods are selected for display by a user, some of those rows may be made larger relative to others of the displayed rows. In one embodiment shown in FIG. 8, a monthly view displaying four weeks, a default view may present the first and second rows, representing the current week and the following week, with a larger area on the display than the last two rows representing the third and fourth weeks from the current date. In the example of FIG. 8, a column begins with the current date as described above. The column may begin with Sunday or Monday as is also known. Instead of displaying the first two weeks with a larger area, only the first week may be displayed with a larger area in an alternative embodiment. As set forth above, the relative size of the rows may be user-defined.

Thus, while the calendar interface 610 stores all user-defined events, the calendar interface 610 allows a user to emphasize the nearest events in the user's event horizon by displaying current time periods with greater detail in a larger space than the future events.

While a monthly view is shown, it is understood that the same concept of displaying the current and imminent time periods larger than more distant time periods may apply to any other selected time period. For example, where a user selects a day view, the current hour or time chunk, and possibly the next hour or next time chunk, may be shown larger than other time periods. As a further example, in a week view, instead of varying the size of the rows, the size of the columns may be varied so that the current day, and possibly one or more following days, are displayed in columns that are larger than the most distant days on the display.

In the embodiments described above, at least the current time period is given the greatest real estate on the calendar interface. However, it may happen that the user has a significant upcoming event, for example hosting a conference, having a wedding, etc. In an alternative embodiment, a time period after the current time period may be provided with the greatest real estate. As indicated above, the real estate for each given time period may be user configurable.

Calendar interface 610 further includes a task pane 660 for storing user-generated tasks. It is further contemplated that a user may add tasks to the calendar interface 610 by selecting a task and dragging onto a specific date. This act causes the task to be saved in the datastore in association with that date. For example, task 662 may be selected and dragged to Today's date. The task will then be displayed on Today's date as shown as well as on the task pane.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer implemented method of emphasizing events in and/or near the current time period, comprising the steps of:
(a) dividing a graphical display into a plurality of discrete areas, each area representing a time period; and
(b) sizing the discrete areas on the display in and/or near the current time period greater than the discrete areas on the display more distant than the current and/or near current time periods.

2. A method as recited in claim 1, further comprising the step (c) of displaying the current time period in the left-most column of the calendar interface.

3. A method as recited in claim 1, said step (b) of sizing the discrete areas comprising the step of automatically sizing the discrete areas.

4. A method as recited in claim 1, further comprising the step (d) of providing configuration tools for allowing a user to size the discrete areas in said step (b).

5. A method as recited in claim 1, further comprising the step (e) of displaying user-defined events within the discrete areas.

6. A method as recited in claim 1, wherein said time period is one of an hour, a day, a week and a month.

7. A method as recited in claim 1, wherein said time period is a user-defined chunk of time.

8. A method as recited in claim 1, wherein said time periods together represent four consecutive weeks of time, one week being displayed in each of four rows.

9. A method as recited in claim 8, wherein the first two rows have a greater area than the last two rows.

10. A method as recited in claim 8, wherein the first row has a greater area than the last three rows.

11. A method as recited in claim 8, wherein a row after the first row has the greatest area.

12. A computer implemented method of emphasizing events in and/or near the current time period, comprising the steps of:
(a) presenting a calendar interface; and
(b) configuring the calendar interface to display the current time period in the left-most column of the calendar interface.

13. A method as recited in claim 12, further comprising the step (c) of sizing areas on the calendar interface in and/or near the current time period greater than areas on the calendar interface more distant than the current and/or near current time periods.

14. A method as recited in claim 12, said step (a) of displaying a calendar interface comprising the step of displaying a week of time, the left-most column displaying the current day.

15. A method as recited in claim 12, said step (a) of displaying a calendar interface comprising the step of displaying one of a day, a month and a year.

16. A method as recited in claim 12, said step (a) of displaying a calendar interface comprising the step of displaying a time period including one or more user-defined chunks of time.

17. In a computer system having a graphical user interface including a display and a user interface selection device, a method of emphasizing events in and/or near the current time period, comprising the steps of:
(a) dividing a graphical display to include one or more columns, each column including one or more rows, a discrete area defined by a row and column representing a time period;
(b) sizing the discrete areas on the display in and/or near the current time period greater than the discrete areas on the display more distant than the current and/or near current time periods; and
(c) displaying the current time period in the left-most column on the graphical display.

18. A method as recited in claim 17, wherein said step (a) of dividing the graphical display into one or more columns, each column including one or more rows, comprises the step of dividing the graphical display to include discrete areas representing one of hours, days, weeks and months.

19. A method as recited in claim 17, wherein said step (a) of dividing the graphical display into one or more columns, each column including one or more rows, comprises the step of dividing the graphical display to include discrete areas representing one or more user-defined chunks of time.

20. A method as recited in claim 17, further comprising the steps of:
(d) adding one or more graphical objects representing tasks to the graphical display; and
(e) associating a task with a time period by selecting the graphical object for that task with the user interface selection device and moving it to the time period.
